(19) United States
(12) Patent Application Publication
(10) Pub. No.: US 2009/0262640 A1
(43) Pub. Date: Oct. 22, 2009

(54) OPTICAL DISC MANUFACTURING METHOD, DISC MASTER MANUFACTURING METHOD, AND OPTICAL DISC

(75) Inventors: Kensaku TAKAHASHI, Kanagawa (JP); Jun NAKANO, Tokyo (JP); Shin MASUHARA, Tokyo (JP); Tetsuhiro SAKAMOTO, Kanagawa (JP); Shigeki TAKAGAWA, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/396,775

(22) Filed: Mar. 3, 2009

(30) Foreign Application Priority Data
Apr. 21, 2008 (JP) 2008-110468

(51) Int. Cl. G11B 7/24; B29C 59/16

(52) U.S. Cl. 369/275.4; 264/447

(57) ABSTRACT

An optical-disc manufacturing method including the steps of: fabricating a pre-exposure disc master by forming, on a substrate, a heat accumulation layer having a thickness of 17% or less of a recording-laser wavelength and forming an inorganic resist layer; performing exposure of a recording-signal pattern having pits and spaces with respect to the inorganic resist layer of the disc master, by performing recording-laser light irradiation; fabricating a disc master having a pit-array shape having pits and spaces, by performing development processing after the exposure; manufacturing a stamper to which the pit-array shape is transferred, by using the disc master having the pit-array shape; and manufacturing an optical disc having a predetermined layer structure including a recording layer to which the pit-array shape of the stamper is transferred and in which a silver or silver-alloy reflective film is formed on the pit-array shape.

### BACKGROUND OF THE INVENTION

1. Field of the Invention

The present invention relates to an optical-disc manufacturing method preferably used for manufacturing high-density optical discs, a disc-master manufacturing method, and an optical disc.

2. Description of the Related Art

In recent years, with an increase in the recording density of optical discs, for example, Blu-ray Discs® are becoming popular as high-density optical discs.

For DVDs (digital versatile discs) that are already widely used, the recording capacity of one DVD (one recording layer) is 4.7 GB (gigabytes). In contrast, the recording capacity of one Blu-ray Disc is 25 GB, which is a significant increase.

Such an increase in the recording density is made possible by producing a finer pit pattern in the mastering process for a disc master.

In traditional mastering processes for up to the DVD generation, organic resists exposed to laser light are photosensitized in a photon mode.

A recording area in the photon mode is proportional to the exposure spot diameter and the resulting resolution is equal to about one-half the value of the spot diameter. The exposure spot diameter φ is expressed by φ=1.22×λ/NA, where λ indicates a laser wavelength, and NA indicates a lens numerical aperture.

In contrast, in the mastering process for the Blu-ray Discs, cutting is performed through the use of an inorganic-material-based resist, which can considerably increase the resolution.

A resist that uses inorganic material is hereinafter referred to as an “inorganic resist”.

Japanese Unexamined Patent Application Publication No. 2003-315988 discloses a technology for a mastering process using an inorganic resist.

The inorganic resist is photosensitized in a heat mode. In the heat mode, only a high-temperature portion in the vicinity of the center of an exposure spot contributes to recording, thus making it possible to provide a finer pattern. Without use of a DUV (deep ultraviolet) wavelength laser, the heat-mode process can provide a sufficient resolution with a blue semiconductor laser. Furthermore, since the semiconductor laser allows for high-rate modulation on the order of gigahertz, the use of a write strategy that is used for recording signals to phase-change discs and magneto-optical discs makes it possible to finely control the pit shapes and thus makes it possible to provide more favorable signal characteristics.

In the write strategy, one pit is recorded with multiple pulses at a high rate, and adjusting the pulse width, the strength, and the pulse interval of each pulse can achieve optimal recording. In addition, with the inorganic resist, since the exposed portion is resolved by alkaline developing that has been typically used, the process does not become complicated.

### SUMMARY OF THE INVENTION

As one scheme for evaluating an optical-disc quality, playback-signal evaluation is available.

In general, playback of an optical disc employs a system in which the disc is irradiated with semiconductor-laser light and return light thereof is detected. Signal characteristics are evaluated by accurately reproducing recorded digital signals.

For a read-only Blu-ray Disc (a ROM Blu-ray Disc with embossed pits) having a recording capacity of 25 GB, the standard states that the disc is rotated at a linear velocity of 4.92 m/s during playback and one clock period is 15.15 ns. Further, the disc has 2T to 8T (30.30 ns to 121.20 ns) pits and spaces (T indicates a channel clock period).

FIG. 8 shows a reproduction waveform (the so-called “eye pattern”) on an analog oscilloscope.

As the depression/projection pitch of pits and spaces is reduced, the read-only optical disc is more likely to be susceptible to a diffraction effect, and thus, the MTF (modulation transfer function) declines and the modulation also decreases. Thus, the smallest amplitude is that of a 2T signal.

In FIG. 8, I8H indicates the peak level of an 8T pattern, I2H indicates the peak level of a 2T pattern, I2L indicates the bottom level of the 2T pattern, and I8L indicates the bottom level of the 8T pattern.

In an actual playback apparatus, a waveform detected as an analog signal is amplified by a non-linear equalizer, an amplitude difference that is depended on a pit length is corrected, and the signal is digitized into 0 and 1 with a threshold being set at a certain voltage level in the vicinity of the center of the amplitude.

As indicators for signal evaluation, jitter, asymmetry, and modulation are mainly used.

With a standard deviation σ and 1T, the jitter is expressed as σ/T, which represents a displacement from a reference clock.

It can be said that the playback signal is degraded as the value of the jitter increases. A standard for read-only Blu-ray Discs having one recording layer specifies that jitter should be 6.5% or less, and naturally, lower jitter is more desirable.

The asymmetry is expressed by {(I8H+I8L)−(I2H+I2L)}/{2(I8H−I8L)}, which represents a displacement of the central axes of an 8T signal and a 2T signal. The asymmetry is an important indicator to determine the threshold for the digitization. While the Blu-ray Disc standard specifies that the asymmetry is −10 to 15%, it is typically desired that the asymmetry be about 0 to 10%.

The modulation is expressed by (I8H−I8L)/(I8H). This represents the size of the amplitude of 8T and serves as an indicator that depends on the depth of an 8T pit. It can be said that the carrier-to-noise ratio improves as the value of this indicator increases.

In the Blu-ray Disc manufacturing procedure, mastering using an inorganic resist is performed as described above to manufacture a disc master, which is then used to fabricate a stamper to which a pit pattern (a recording signal pattern having pits and spaces) is transferred therefrom.

The stamper is then used to mass-produce optical discs.

FIG. 9 schematically shows the layer structure of an optical disc. In the mass-production procedure, for example, with the stamper being placed in a mold, injection molding is performed to mold, for example, a polycarbonate disc substrate 200 (i.e., a plastic transfer substrate) to which a depression/projection pit-array shape 201 (which corresponds to a pit pattern) is transferred. A reflective film 202 is deposited on the pit pattern 201 to provide a recording layer. In addition, a cover layer 203 is formed the recording layer (specifically, a side on which laser light is incident) to manufacture an optical disc.

In such optical-disc mass-production, the process in which the pattern is transferred to a large number of disc substrates to the process in which the cover layers are laminated thereto are completely automated, and thus, statistic variations that are unavoidable in the mass production occur.

Presently, for the reflective film, an Ag (silver) alloy that allows for relatively easy control of the reflectivity and that can be used for two-layer discs because of its low absorption rate in blue wavelengths is generally used. The Ag alloy layer is set to have a film thickness of 35 nm, from the point of view of the amount of return light and anti-corrosion measures. However, the reflective-film deposition also has variations, which greatly affect the playback signal characteristics.

Unlike playback mechanisms of CDs and DVDs, a playback mechanism of read-only Blu-ray Discs is to detect reflection light by irradiating the cover layer 203 with laser light 250, as shown in FIG. 9. Thus, the amount of return light is highly dependent on the shape of the reflective film 202. This is because a change in the film thickness causes changes in the film optical characteristics (reflectivity and transmittance), the pit shapes on the layer, and so on.

In the current situation, during the manufacture, the thickness of the reflective films vary on the order of several millimeters and the reflectivity of the reflective films of optical discs to be manufactured vary in the range of 45 to 55%.

As described above, the pit shape on the disc substrate 200, the pit shape being transferred from the stamper manufactured using the disc master, is optimized to only the film thickness of a target center value of the reflective film 202 (e.g., to a film thickness with a reflectivity of 45%). Under such a situation in which the thickness of the reflective films varies and optical discs manufactured have various different optical characteristics, the playback signal characteristics, such as jitter and asymmetry values, fluctuate and thus may result in non-conformance with the standard.

FIGS. 10A, 10B, and 10C show reflective-film thickness (reflectivity) dependencies of jitter, asymmetry, and modulation, respectively, when the Ag-alloy films for read-only Blu-ray Discs that are currently manufactured are deposited with the film thickness being varied in a wide range.

In FIGS. 10A, 10B, and 10C, the horizontal axes indicate the reflectivity, and the jitter, asymmetry, and modulation are measurement results obtained from a large number of Blu-ray Discs having different reflectivities.

As can be understood from the results, a jitter or 5.3% and an asymmetry of 9.7% which conform to the standard are obtained with a reflectivity of 45%. However, when the reflectivity increases to 60%, for example, the jitter value deteriorates by 2% or more and the asymmetry also increases to 12%. This indicates that productivity declines in the manufacture in which the thickness of the reflective films varies.

This is possibly because variations in the modulation have some influence on the long pits, such as 8T pits, according to an increase in the film thickness.

As described above, in the today's manufacture of read-only Blu-ray Discs, when the thicknesses of the Ag-alloy reflective films of the discs vary by about ±5% because of manufacture error, target exchange, or the like, considerable changes that involve an increase in the amount of jitter of the playback signal characteristics occur, thus posing the problem of affecting the productivity.

Accordingly, it is desirable to prevent such signal-characteristic deterioration relative to variations in the reflective film thickness.

According to an embodiment of the present invention, there is provided an optical-disc manufacturing method. The optical-disc manufacturing method includes the steps of: fabricating a pre-exposure disc master by forming, on a substrate, a heat accumulation layer having a thickness of 17% or less of a recording-laser wavelength and forming an inorganic resist layer; performing exposure of a recording-signal pattern having pits and spaces with respect to the inorganic resist layer of the disc master, by performing recording-laser light irradiation; fabricating a disc master having a pit-array shape having pits and spaces, by performing development processing after the exposure; manufacturing a stamper to which the pit-array shape is transferred, by using the disc master having the pit-array shape; and manufacturing an optical disc having a predetermined layer structure including a recording layer to which the pit-array shape of the stamper is transferred and in which a silver or silver-alloy reflective film is formed on the pit-array shape.

In the optical-disc manufacturing step, preferably, at least a cover layer is formed, as the layer structure, on a side of the recording layer having the reflective film, playback laser light being incident on the side. Preferably, the pits of the pit-array shape transferred using the stamper have a shape that satisfies dl≦0.20(λ/n) and dl−ds≦1/30(λ/n), where ds indicates a depth of a shortest pit, dl indicates a depth of a long pit having a predetermined length or more, n indicates a reflectivity of the cover layer, and k indicates a wavelength of the playback laser light.

According to another embodiment of the present invention, there is provided a disc-master manufacturing method. The disc-master manufacturing method includes the pre-exposure disc-master fabricating steps, the recording-signal-pattern exposure performing step, and the disc master fabricating step of the above-described optical-disc manufacturing method.

According to another embodiment of the present invention, there is provided an optical disc. The optical disc includes: a recording layer in which a pit-array shape having pits and spaces and a reflective film having silver or a silver alloy are formed; and a cover layer formed at a side of the recording layer, playback laser light being incident on the side. The pits of the pit-array shape have a shape that satisfies dl≦0.20(λ/n) and dl−ds≦1/30(λ/n), where ds indicates a depth of a shortest pit, dl indicates a depth of a long pit having a predetermined length or more, n indicates a reflectivity of the cover layer, and λ indicates a wavelength of the playback laser light.

Preferably, the pit-array shape is transferred to the recording layer by illuminating an inorganic resist layer with recording-laser light to perform exposure of a recording-signal pattern having pits and spaces, performing development processing, fabricating a stamper to which the pit-array shape is transferred through use of a disc master having a pit-array shape having pits and spaces, and using the stamper.

For high-density recording optical discs such as Blu-ray Discs, lithography using an inorganic resist is used to manufacture a disc master.

A high-density recording optical disc indented by the present invention is a disc in which reproduction signals are read from its reflective film side and for which an objective lens having a high NA (e.g., 0.7 or more) is used as a playback optical system. As the reflective film of the optical disc, Ag or an Ag-based alloy is used.

Then, inorganic resist is used to manufacture a disc master, and the pit-array shape formed on the disc master is transferred to a recording layer of an (read only) optical disc that is eventually mass-produced. The pit length of the pit-array shape causes a difference in depth. For a Blu-ray Disc, 2T to 8T pits are formed. The 2T pit, which is the shortest pit, tends to have the smallest depth, and 4T to 8T pits, which are long pits, tend to have substantially the same depth that is the deepest.

The inventors of the present invention found that reducing a long pit (to 20% or less of a penetrating light wavelength (λ/n)) and reducing a difference relative to a shortest pit (e.g., a 2T pit) to 1/30th of the penetrating light wavelength can prevent signal characteristics from deteriorating relative to variations in the reflective film thickness. Such a pit depth is achieved by adjusting the thickness of the heat accumulation layer of the disc master.

The present invention can provide some advantages.

Specifically, since signal characteristics that are less susceptible to a reflectivity change are obtained, the productivity of high-recording-density optical discs, such as read-only Blu-ray Discs, is enhanced.

In addition, there is no need to consider the pit shape for each reflective-film thickness. This means that, even when the recording layer is used as a first recording layer with a high reflectivity suitable for a multi-layer disc, it can be used under the same cutting conditions as those for a one-layer read-only Blu-ray Disc.

Additionally, according to the present invention, in a mastering process in which the signal characteristics deteriorate due to large reflectivity dependency, it is possible to easily control the signal characteristics by adjusting the heat accumulation layer and by slightly adjusting recording power. Thus, there is an advantage in that the present invention can be easily applied to a manufacturing process.

### BRIEF DESCRIPTION OF THE DRAWINGS

FIGS. 1A to 1J illustrate an optical disc manufacturing procedure according to an embodiment of the present invention;

FIG. 2A illustrates a pit shape of related art and FIG. 2B illustrate a pit shape according to the present embodiment;

FIGS. 3A to 3C illustrates pit shapes of samples used for verification of the present embodiment;

FIGS. 4A to 4C illustrate pit shapes of samples used for verification of the present embodiment;

FIG. 5 is a graph illustrating a jitter characteristic versus a reflectivity change in the present embodiment;

FIG. 6 is a graph illustrating an asymmetry characteristic versus a reflectivity change in the present embodiment;

FIG. 7 is a graph illustrating a modulation characteristic versus a reflectivity change in the present embodiment;

FIG. 8 illustrates playback signal waveforms;

FIG. 9 is a diagram illustrating a layer structure of an optical disc; and

FIGS. 10A to 10C are graphs illustrating signal characteristics of an optical disc of related art.

### DESCRIPTION OF THE PREFERRED EMBODIMENTS

An embodiment of the present invention will be described in the following order:
[1. Disc Manufacturing Procedure],
[2. Mastering using Inorganic Resist],
[3. Optical Disc to be Manufactured], and
[4. Verification]

### [1. Disc Manufacturing Procedure]

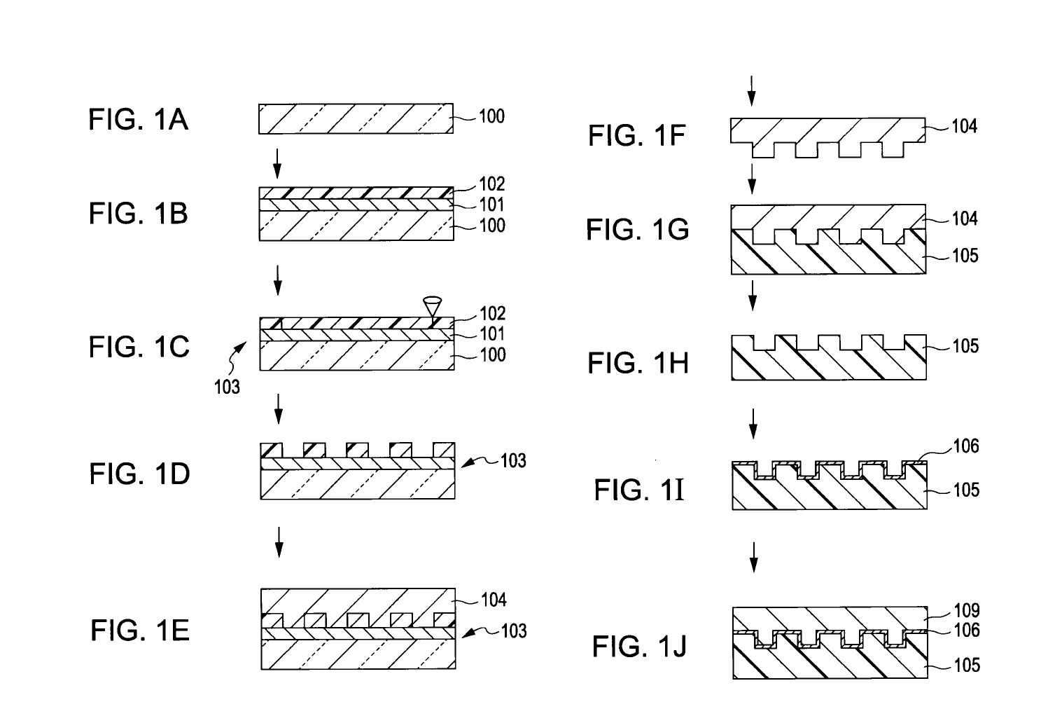

A procedure for manufacturing an optical disc will first be described with reference to a schematic diagrams shown in FIGS. 1A to 1J.

FIG. 1A shows a master formation substrate 100 that provides a disc master. The master formation substrate 100 may be made of, for example, a silicon wafer or quartz.

A heat accumulation layer 101 and an inorganic resist layer 102 are deposited on the master formation substrate 100 by sputtering, as shown in FIG. 1B.

Next, as shown in FIG. 1C, through the use of a master manufacturing apparatus, which is described below, selective exposure corresponding to a pit array (which serves as a recording-signal pattern) is performed on the inorganic resist layer 102, so that the resulting resist layer is photosensitized.

The inorganic resist layer 102 is then subjected to developing (etching) to thereby fabricate a disc master 103 having a predetermined depression/projection pit pattern (a pit-array shape having pits and spaces) as shown in FIG. 1D.

Subsequently, as shown in FIG. 1E, a metal nickel film is deposited on the depression/projection surface of the fabricated disc master 103 and is removed from the disc master 103, and the resulting disc master 103 is then subjected to predetermined processing to thereby provide a mold stamper 104 (in FIG. 1F) to which the pit-array shape of the disc master 103 is transferred.

The stamper 104 is used to mold a resin disc substrate 105 (in FIG. 1G) by injection molding. The resin disc substrate 105 may be made of polycarbonate, which is a thermoplastic resin.

Thereafter, the stamper 104 is removed (in FIG. 1H) and, as shown in FIG. 1I, an Ag or Ag-alloy reflective film 106 is deposited on the depression/projection surface of the resin disc substrate 105, i.e., on the surface having the pit-array shape transferred from the stamper 104. The depression/projection pit-array shape and the reflective film 106 provide a recording layer.

As shown in FIG. 1J, a cover layer 109 is formed on a laser-incident side of the recording layer to manufacture a read-only optical disc (e.g., a Blu-ray Disc).

A hard-coat layer may further be formed on the surface of the cover layer 109 or a moisture-proof film may be formed on a surface (a label printing surface) of the disc substrate 105.

[2. Mastering Using Inorganic Resist]The processes shown in FIGS. 1A, 1B, 1C, and 1D correspond to the manufacture of the disc master, and a description is now given of mastering using an inorganic resist.

As described above, an inorganic resist is photosensitized in a heat mode in which only a high-temperature portion in the vicinity of the center of an exposed spot contributes to recording. This can provide a higher-density pattern. Without use of a DUV wavelength laser, the heat-mode process can obtain a sufficient resolution with a blue semiconductor laser. Furthermore, with the inorganic resist, since an exposed portion is resolved by alkaline developing that has been typically used, the process does not become complicated. Thus, the inorganic resist is suitable for the manufacture of high-density optical discs, such as Blu-ray Discs.

The disc master 103 using the inorganic resist has a two-layer structure in which, as shown in FIG. 1B, the heat accumulation layer 101 and the inorganic resist layer 102 are deposited on the silicon-wafer or quartz master-formation substrate 100 by sputtering in that order.

For example, amorphous silicon is used for the heat accumulation layer 101. This heat accumulation layer 101 acts to prevent diffusion of thermal energy, given by the exposure, so as to efficiently heat the inorganic resist layer 102. However, when the heat accumulation layer 101 is too thick, excessive heating occurs and the resolution deteriorates. Typically, the thickness of the heat accumulation layer 101 is set to about 70 to 100 nm. In the case of the present embodiment, however, the thickness of the heat accumulation layer 101 is 17% or less of a laser wavelength, as described below.

An incomplete oxide of transition metal, such as tungsten or molybdenum, is used for the inorganic resist layer 102. This material is selected since the inorganic oxide is sensitive to the wavelengths of blue to ultraviolet and provides an exposed portion with a high solubility in an alkaline developer. In general, the inorganic resist layer 102 is deposited to have a slightly larger thickness than a desired pit depth.

In the process shown in FIG. 1C, a blue semiconductor laser with a wavelength of about 405 nm is used to emit beams modulated in accordance with recording signals, and an objective lens having a numerical aperture (NA) of about 0.9 focuses the beams on the surface of the disc master 103 to thereby perform thermal recording.

The disc master 103 is placed on a turntable on an exposure apparatus, is rotated at a speed according to a recording linear velocity, and is moved relative to the objective lens with a constant feed pitch (track pitch) in the radial direction.

After the completion of the exposure, developing using a typical organic alkaline developer is performed on the disc master 103, so that the depressions/projections are formed on the disc master 103 as a pit array shape, as shown in FIG. 1D. When a tungsten oxide is used for the inorganic resist layer 102, the exposed portion becomes alkaline soluble (i.e., a positive type).

Typical pits for organic resist processes that have been employed for CDs and DVDs of the related art have a semicylindrical shape having a curved bottom, whereas a phenomenon that is characteristic of inorganic resist processes is that the pits have the so-called “soccer stadium” shape with a flat bottom and a trapezoidal cross section.

This is because the developing of the inorganic resist layer 102 does not reach a disc master interface (more specifically, an interface with the heat accumulation layer 101).

Part of heat given to the inorganic resist layer 102 by the laser exposure is absorbed in the layer during penetration from the surface of resist layer 102 to the bottom portion thereof and also part of the heat escapes to the master formation substrate 100. Thus, the deepest portion is not sufficiently heated, thus making the reaching of the development difficult.

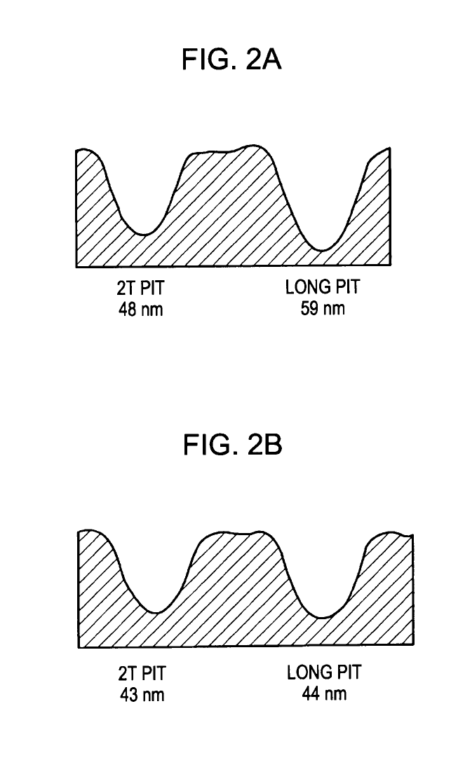

As a result, the development is stopped in the resist layer (this phenomenon is generally called “half tone”) and the pit bottom portions are curved as shown in FIG. 2A and 2B.

In a presently used disc-master deposition process (which does not correspond to the embodiment of the present invention), the thickness of the heat accumulation layer 101 is set to 17% or more of the recording-laser wavelength, and thus the heat accumulation effect is large.

Thus, when lithography is performed in the next process, 4T to 8T pits to which a large amount of heat is applied are photosensitized to a depth of 20% or more of the laser wavelength. In contrast, 2T pits to which a small amount of heat is applied do not sufficiently gain the effect of the heat accumulation layer 101 and the photosensitization depth is relatively small compared to the deepest pit.

Thus, the depth of the pit-array shape formed on the disc master 103 differs depending on the pit length. Naturally, the depth of the pit-array shape (which acts as the optical-disc recording layer) formed through transfer from the disc master 103 and the stamper 104 also differs depending on the pit length.

For a Blu-ray Disc, 2T to 8T pits are formed. The 2T pit, which is the shortest pit, tends to have the smallest depth, and 4T to 8T pits, which are long pits, tend to have substantially the same depth that is the deepest.

### [3. Optical Disc to be Manufactured]

As described in the manufacturing procedure shown in FIGS. 1A to 1J, on the disc substrate 105 formed using the stamper 104, the reflective film 106 that is made of silver or a silver-based alloy is deposited on the surface having the transferred pit-array shape.

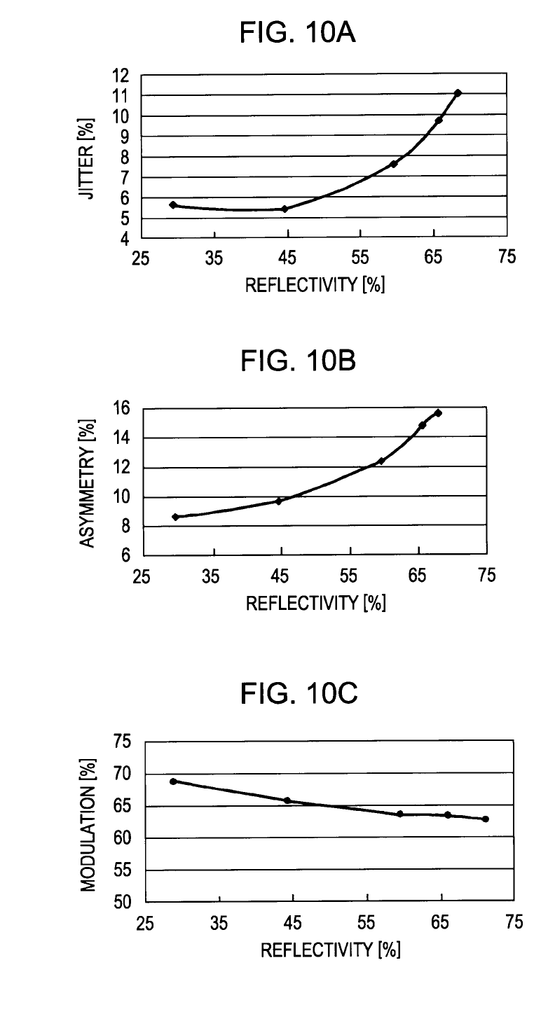

Due to error of the thickness of the reflective film 106, the reflectivity varies in the range of about 45 to 60%, and as also described in FIGS. 10A to 10C, the variations in the reflectivity make signal characteristics unstable. In particular, for an optical disc having a reflectivity of 50% or more, deterioration of a jitter characteristic and an asymmetry characteristic become prominent.

The inventors of the present invention investigated a cause of the deterioration of the signal characteristics and found that it is caused by the pit shape.

Accordingly, the present embodiment of the present invention provides an optical disc having a pit shape as described below and a manufacturing method therefor.

More specifically, the present embodiment is aimed to achieve a jitter increase of 1.5% or less and an asymmetry increase of 2% or less even when error in the thickness of the reflective film 106 causes the reflectivity to vary in the range of 45 to 60%.

First, a description will be given of the pit shapes of an optical disc having signal characteristics that are unstable relative to variations in the thickness of the reflective film.

FIG. 2A is a radial sectional view of a recording layer of a manufactured optical disc of the related art and shows the pit shape of a 2T pit, which is the shortest pit, and the pit shape of a long pit (a pit of 4T or more).

In the example shown in FIG. 2A, the depth of the 2T pit is 48 nm and the depth of the long pit is 59 nm.

The depth of the 2T pit is about 19% of the wavelength of the penetrating laser light, whereas the depth of the long pit is about 23% of the wavelength of the laser light. Thus, there is a great difference between the depths. For a Blu-ray Disc, the wavelength of the laser light is 405 nm and the reflectivity of the cover layer 109 is 1.54.

Such a difference between the pit depths is produced by the above-described reason. That is, for the 2T pit, in the mastering stage of the disc master 103 using the inorganic resist, the amount of applied heat is small and thus the heat does not penetrate the resist bottom portion.

In the mastering stage, the laser exposure is performed using the so-called “PTM (phase transition mastering) system”. As a write strategy for the exposure laser, for example, a single recording pulse that uses a first pulse is used for the 2T pit, multiple recording pulses using a first pulse and a last pulse are used for a 3T pit, and multiple recording pulses using a first pulse, a multi pulse (or multi pulses), and a last pulse are used for a 4T pit or more. For the 4T to 8T pits, the number of multi pulses is different from each other. The reason why the amount of applied heat is small for the 2T pit is that the write strategy is a single recording pulse.

As opposed to the 2T pit, when the heat accumulation layer 101 has a thickness of 17% or more of the recording-laser wavelength, the heat accumulation effect increases for the exposure of long pits with 4T or more. Consequently, the photosensitive volume increases, so that deeper pits are formed.

The reflective-film thickness dependency has causes. Specifically, in the optical disc having the transferred pit-array shape of the disc master 103, as the reflectivity at the pit bottom surface increases according to an increase in the thickness of the reflective film 106, optical behavior of, for example, an electric field of light that penetrates the pits changes. In particular, the deeper the pit is, the more complicated the behavior of the electric field of the penetrating light is.

In this case, in an optical disc whose pit depth varies greatly depending on the pit length, as shown in FIG. 2A, the electric-field behavior varies depending on the pit length and thus the relative electric-field behavior changes according to the reflectivity. As a result, a difference in the amount of return light occurs, and thus, the playback signals deteriorate according to an increase in the reflectivity.

Accordingly, in the present embodiment, the long pit is set to have a depth of about 50 nm, which is about 20% of the penetrating light wavelength, without a change in the depth of the 2T pit.

In addition, the differences among the depths of all pits are made to be 1/30th or less of a penetrating wavelength.

That is, the bottom level of a playback signal of the 8T pit is increased and the modulation is reduced. According to the standard of the today's read-only Blu-ray Discs, the modulation is 40% or more, and thus, a modulation of about 60% can be ensured even when the depth is 50 nm. Thus, there is no problem.

A reduction in the depth of long pits can make the electric field less complicated and a reduction in a difference between a shortest pit and the long pits can eliminate a relative difference between the electric field behaviors. As a result, it is possible to reduce an influence due to optical variations that occur in a thick reflective film.

A method used in order to reduce the depth of only the long pits is that the thickness of the heat accumulation layer 101 deposited below the inorganic resist layer 102 on the disc master 103 is set to be 17% or less of the laser wavelength to thereby reduce the heat accumulation effect so that the depths of the long pits becomes closer to the pit of the 2T pit.

As described above, since the amount of heat at the bottom portion of the inorganic resist layer 102 is not sufficient compared to a portion in the vicinity of the surface of the inorganic resist layer 102, the presence of the heat accumulation layer 101 has a large influence on, particularly, the sensitivity of the resist bottom portion and the pit depth can be controlled using the film thickness of the heat accumulation layer 101.

Typically, the thickness of the heat accumulation layer 101 is 17% or more of the recording-laser wavelength and the heat accumulation effect is considerably high. Thus, the long pits to which a large amount of large energy is applied increase in the photosensitive volume, and thus have a large depth compared to the 2T pit, as shown in 2A.

In this case, when the heat accumulation layer 101 is set to have a thickness that is 17% or less of the laser wavelength, reducing the heat accumulation effect can suppress an increase in the depth of the long pit.

FIG. 2B shows a cross section of the recording layer of the optical disc according to the present embodiment. In this case, the depth of the 2T pit is 43 nm and the depth of the long pit is 44 nm. That is, the depth of the long pit is made very close to the depth of the 2T pit. Suppressing an increase in the depth of the long pit and making the depth close to that of the 2T pit, as described above, can be realized by setting the thickness of the heat accumulation layer 101 of the disc master 103.

Signal characteristics of such an optical disc are less likely to deteriorate relative to film-thickness variations (reflectivity variations) in the reflective film 106.

As another scheme for controlling the pit depth, a write strategy is available. The write strategy employs multi-pulse writing, with which adjustment of the pulse width, the strength, and the pulse interval makes it possible to control the pit depth.

However, with the write strategy set for each 2T to 8T, adjusting independent parameters for the pulse width, the strength, and the pulse interval for each T involves a large amount of effort in order to improve the signal characteristics.

In contrast, the scheme for adjusting the thickness of the heat accumulation layer 101 during deposition thereof can be said as a simpler depth-control scheme.

### [4. Verification]

A description will now be given of an example of verifying that a disc that is low in deterioration of signal characteristics, as described above, can be obtained.

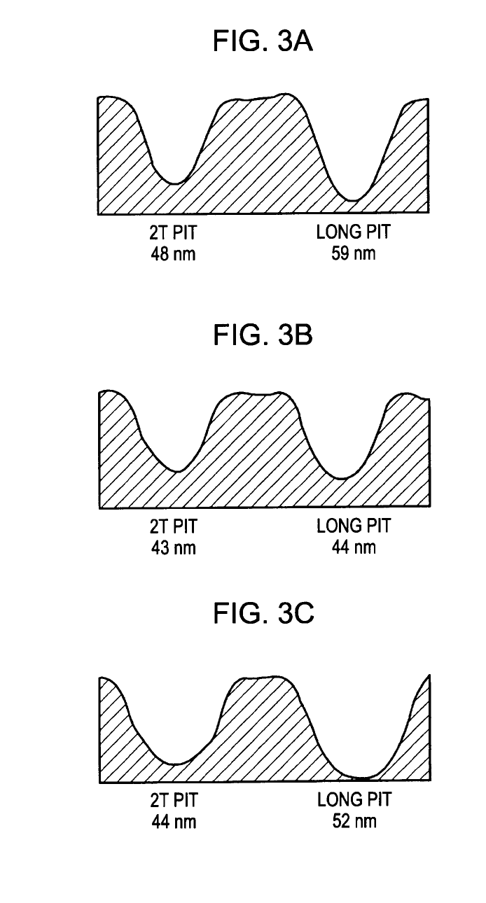

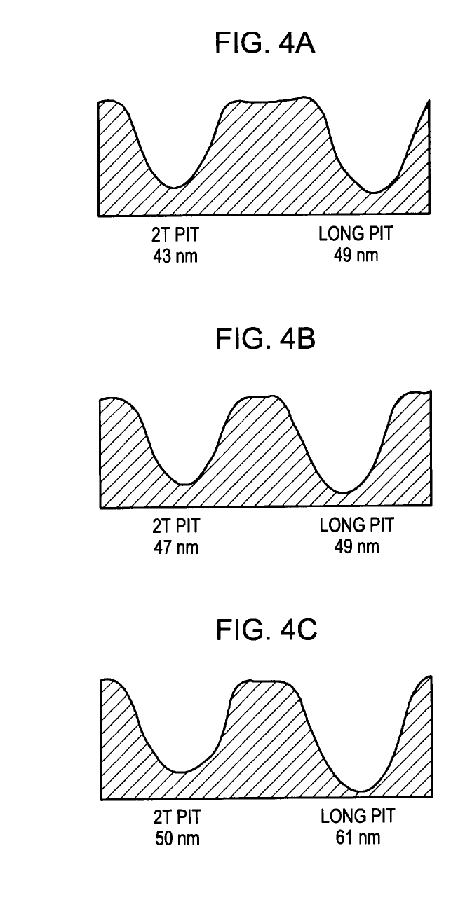

The inventors of the present invention created optical discs having pit shapes, as samples 1, 2, 3, 4, 5, and 6 shown in FIGS. 3A, 3B, 3C, 4A, 4B, and 4C, respectively, and measured reflective dependences of the signal characteristics. FIGS. 3A to 4C were drawn based on pit shapes observed as AFM (atomic force microscope) images.

Each sample has following parameters, and in this case, ds indicates the depth of a shortest pit (2T pit), dl indicates the depth of a long pit (4T to 8T), n indicates the reflectivity of the cover layer 109, and k indicates the wavelength of the playback layer light.

### Sample 1

Heat Accumulation Layer of Disc Master: 70 nm (17.3% of Laser Light)

Depth of 2T Pit: 48 nm

Depth of Long Pit: 59 nm

This is given by dl>0.20(λ/n), dl−ds>1/30(λ/n)

### Sample 2

Heat Accumulation Layer of Disc Master: 40 nm (9.9% of Laser Light)

Depth of 2T Pit: 43 nm

Depth of Long Pit: 44 nm

This is given by dl<0.20(λ/n) and dl−ds<1/30(λ/n)

### Sample 3

Heat Accumulation Layer of Disc Master: 60 nm (14.8% of Laser Light)

Depth of 2T Pit: 44 nm

Depth of Long Pit: 52 nm

This is given by dl=0.20(λ/n) and dl−ds>1/30(λ/n)

### Sample 4

Heat Accumulation Layer of Disc Master: 40 nm (9.9% of Laser Light)

Depth of 2T Pit: 43 nm

Depth of Long Pit: 49 nm

This is given by dl<0.20(λ/n) and dl−ds<1/30(λ/n)

### Sample 5

Heat Accumulation Layer of Disc Master: 40 nm (9.9% of Laser Light)

Depth of 2T Pit: 47 nm

Depth of Long Pit: 49 nm

This is given by dl<0.20(λ/n) and dl−ds<1/30(λ/n)

### Sample 6

Heat Accumulation Layer of Disc Master: 70 nm (17.3% of Laser Light)

Depth of 2T Pit: 50 nm

Depth of Long Pit: 61 nm

This is given by dl>0.20(λ/n) and dl−ds>1/30(λ/n)

With respect to samples 1 to 6, optical discs having different film thicknesses (i.e., reflectivities) of the reflective films 106 were prepared and playback signal characteristics were measured.

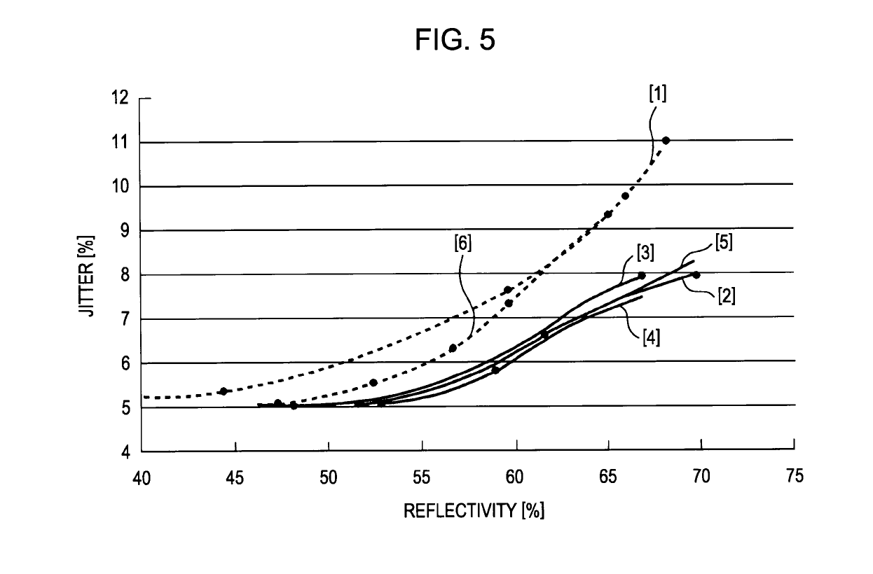

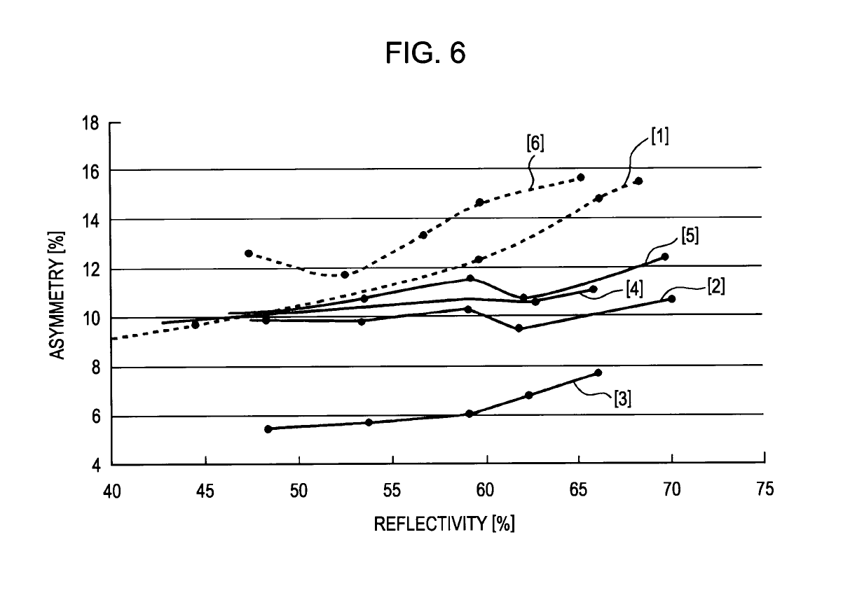

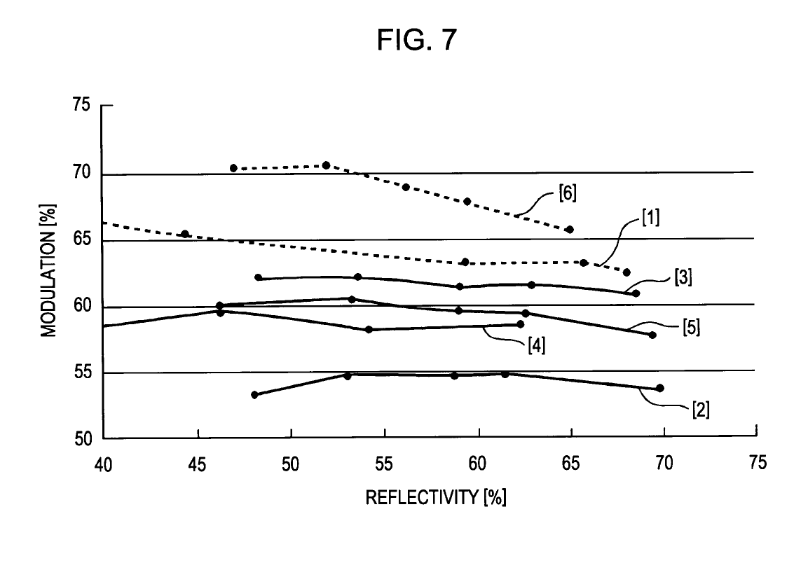

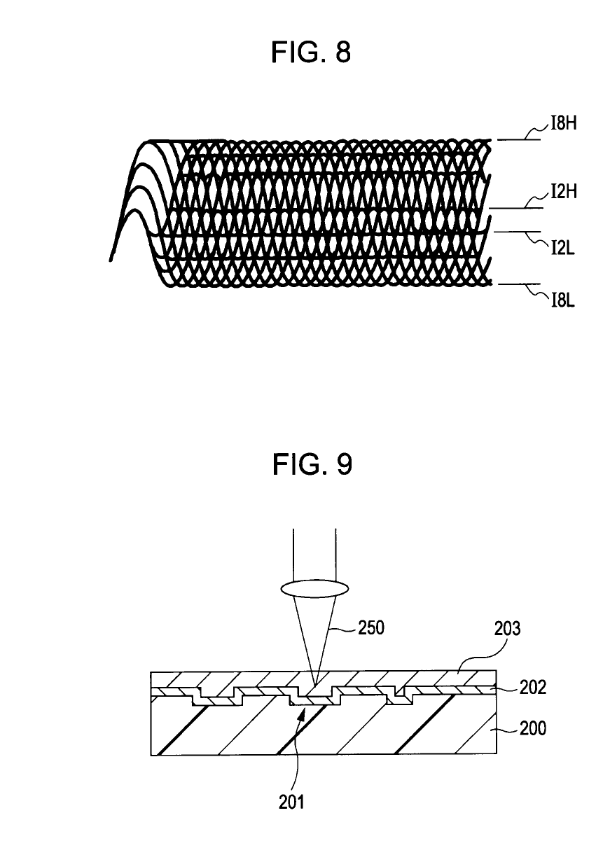

FIGS. 5, 6, and 7 show playback-signal characteristics of samples 1 to 6. In each figure, the horizontal axis indicates the reflectivity of the reflective film 106. FIG. 5 shows a jitter characteristic versus reflectivity, FIG. 6 shows an asymmetry characteristic versus reflectivity, and FIG. 7 shows a modulation characteristic versus reflectivity. Characteristic curves denoted by [1] to [6] in each figure correspond to the numbers of the samples.

From the pit shapes shown in FIGS. 3A to 4C and the modulation characteristics shown in FIG. 7, it was observed that the long pits become deep for samples (i.e., samples 1 and 6) whose heat accumulation layers 101 are thicker than or equal to 17% of the recording-laser wavelength and it was also confirmed that the depths of the long pits can be controlled by adjusting the thickness of the heat accumulation layer.

Samples 1 and 6 are examples that are not included in the present embodiment and are thus indicated by dotted lines in FIGS. 5, 6, and 7. In the cases of samples 1 and 6, at a reflectivity of 45 to 60%, the jitter increase is about 2.5% and the asymmetry increase (variation) is 2.5% or more, and thus, the reflectivity dependency is high. This shows that the productivity is unstable.

In contrast, the thicknesses of the heat accumulation layers 101 in samples 2, 3, 4, and 5 are less than 17% of the laser wavelength, and thus these examples are included in the embodiment of the present invention and also satisfy the following conditions:

dl<0.20(λ/n),

where dl indicates the depth of 4T to 8T pits and n indicates the reflectivity of the cover layer, or

dl−ds<1/30(λ/n),

where the modulation is 63% or less and ds indicates the depth of the shortest pit (2T).

In samples 2, 3, 4, and 5, it can be confirmed that the jitter increase is reduced to 1.5% or less or the asymmetry increase is reduced to 2% or less in the range in which the reflectivity is 45 to 60%. Thus, this verification example provided data that proves the present invention.

In particular, high stability is ensured in the range in which the reflectivity is 45 to 55% in which variations occur during manufacture.

However, when the depths of the long pits are reduced to be closer to that of the 2T pit, the absolute value of the asymmetry increases. Actually, sample 5 has an asymmetry of about 11%.

Accordingly, in order to ensure certain levels of signal stability and the absolute value of the asymmetry, it is recommended that the difference in depth between the 2T pit and the long pit be set to about 1/30th of the penetrating wavelength.

In view of the above-described results, making the depth of the long pit closer to the depth of the 2T pit can offer some advantages during manufacture of read-only Blu-ray Discs.

Specifically, since signal characteristics that are less susceptible to reflectivity variations are obtained, the productivity of the read-only Blu-ray Discs is enhanced.

In addition, there is no need to consider the pit shape for each reflective-film thickness. This means that, even when the recording layer on the disc substrate 105 manufactured as in processes in FIG. 1A to 1I is used as a first recording layer with a high reflectivity suitable for a multi-layer disc, it can be used under the same cutting conditions as those for a one-layer read-only Blu-ray Disc.

This scheme for controlling the pit depth by changing the thickness of the heat accumulation layer 101 can be easily employed in the mastering process.

Although the above description has been given of an example of the Blu-ray Discs, the present invention is preferably applied to other optical discs, particularly, optical discs that are equivalent to Blu-ray Discs or optical discs that have a recording density higher than that of the Blu-ray Discs.

The present application contains subject matter related to that disclosed in Japanese Priority Patent Application JP 2008-110468 filed in the Japan Patent Office on Apr. 21, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An optical-disc manufacturing method comprising the steps of:
fabricating a pre-exposure disc master by forming, on a substrate, a heat accumulation layer having a thickness of 17% or less of a recording-laser wavelength and forming an inorganic resist layer;
performing exposure of a recording-signal pattern having pits and spaces with respect to the inorganic resist layer of the disc master, by performing recording-laser light irradiation;
fabricating a disc master having a pit-array shape having pits and spaces, by performing development processing after the exposure;
manufacturing a stamper to which the pit-array shape is transferred, by using the disc master having the pit-array shape; and
manufacturing an optical disc having a predetermined layer structure including a recording layer to which the pit-array shape of the stamper is transferred and in which a silver or silver-alloy reflective film is formed on the pit-array shape.

2. The manufacturing method according to claim 1, wherein in the optical-disc manufacturing step, at least a cover layer is formed, as the layer structure, on a side of the recording layer having the reflective film, playback laser light being incident on the side, and
wherein the pits of the pit-array shape transferred using the stamper have a shape that satisfies
dl<0.20(λ/n) and
dl−ds<1/30(λ/n),
where ds indicates a depth of a shortest pit, dl indicates a depth of a long pit having a predetermined length or more, n indicates a reflectivity of the cover layer, and λ indicates a wavelength of the playback laser light.

3. A disc-master manufacturing method comprising the steps of:
fabricating a pre-exposure disc master by forming, on a substrate, a heat accumulation layer having a thickness of 17% or less of a recording-laser wavelength and forming an inorganic resist layer;
performing exposure of a recording-signal pattern having pits and spaces with respect to the inorganic resist layer of the disc master, by performing recording-laser light irradiation; and
fabricating a disc master having a pit-array shape having pits and spaces, by performing development processing after the exposure.

4. An optical disc comprising:
a recording layer in which a pit-array shape having pits and spaces and a reflective film having silver or a silver alloy are formed; and
a cover layer formed at a side of the recording layer, playback laser light being incident on the side,
wherein the pits of the pit-array shape have a shape that satisfies
dl<0.20(λ/n) and
dl−ds<1/30(λ/n),
where ds indicates a depth of a shortest pit, dl indicates a depth of a long pit having a predetermined length or more, n indicates a reflectivity of the cover layer, and λ indicates a wavelength of the playback laser light.

5. The optical disc according to claim 4, wherein the pit-array shape is transferred to the recording layer by illuminating an inorganic resist layer with recording-laser light to perform exposure of a recording-signal pattern having pits and spaces, performing development processing, fabricating a stamper to which the pit-array shape is transferred through use of a disc master having a pit-array shape having pits and spaces, and using the stamper.
